(19) United States
(12) Patent Application Publication
(10) Pub. No.: US 2004/0126284 A1
(43) Pub. Date: Jul. 1, 2004

(54) System and method for a combination breath analysis device and credit card

(76) Inventors: Joseph D. Lilly, Richmond, VA (US); Jeffrey E. Peed, Richmond, VA (US)

Correspondence Address: BAKER BOTTS L.L.P., 2001 ROSS AVENUE, SUITE 600, DALLAS, TX, 75201-2980, US

(21) Appl. No.: 10/335,388

(22) Filed: Dec. 31, 2002

(51) Int. Cl. G01N 1/00

(52) U.S. Cl. 422/119

(57) ABSTRACT

According to one embodiment of the invention, a credit card is combined with a breath analysis device. The breath analysis device may be coupled to a credit card as either a single unit, or in such a manner that the credit card may be detached from the breath analysis device. The credit card may have a cut-out portion formed therein operable to open containers.

### TECHNICAL FIELD OF THE INVENTION

This invention relates generally to the field of credit card devices and more particularly to a method and system for combining a credit card with a breath analysis device.

### BACKGROUND OF THE INVENTION

Consumers frequently use credit cards to purchase alcoholic beverages at restaurants, bars, and nightclubs. For example, instead of paying cash for individual drinks in any given evening, a consumer may use a credit card to start a tab with the bartender or wait staff and close out the tab at the end of the evening.

Personal breath analysis devices, such as the ABT-180 alcohol breath tester manufactured and marketed by Matsutek Enterprises Co., Ltd., enable a user to conduct a self-analysis of the user's blood alcohol content. The BT-5500 personal alcohol detector marketed by Gibbs and Associates is another example of a personal alcohol detector that can measure blood alcohol content for an individual consumer.

### SUMMARY OF THE INVENTION

According to one embodiment of the invention, a credit card and a breath analysis device are combined into one device. Additional embodiments include the combination breath analysis device and credit card having an opening that is operable to open bottles that are sealed with bottle caps. According to another embodiment, a method is provided whereby a credit card is rotatably coupled to a breath analysis device. In yet another embodiment, the credit card is removably coupled to the breath analysis device so that the credit card may be removed and used in devices such as automatic teller machines, manual card readers, or carried in a consumer's wallet or purse. Another embodiment comprises a container coupled to a credit card. In this embodiment, the container may be operable to store chemical test equipment for determining the blood alcohol level of an individual. The method includes coupling a credit card to a breath analysis device, and may include the additional step of creating a cutout portion of the credit card operable to open bottles sealed with bottle caps.

Some embodiments of the invention provide numerous advantages. For example, a credit card coupled with a breath analysis device provides a ready means for a consumer to test his or her blood alcohol content prior to purchasing an additional alcoholic beverage. Additionally, the combination credit card with a bottle opener provides a ready means for opening bottles sealed with bottle caps without the necessity of the consumer carrying a different apparatus which would normally be required for opening such vessels.

Other advantages may be readily ascertained by one of ordinary skill in the art.

### BRIEF DESCRIPTION OF THE DRAWINGS

Reference is now made to the following description taken in conjunction with the accompanying drawings, wherein like reference numbers represent like parts, in which:

FIG. 1 illustrates a credit card in accordance with the prior art;

FIG. 1A illustrates a credit card, in accordance with the prior art;

FIG. 2 illustrates a front view of a breath analysis device combined with a credit card, in accordance with an embodiment of the present invention;

FIG. 2A illustrates a back view of a credit card combined with a breath analysis device, in accordance with an embodiment of the present invention;

FIG. 3 illustrates a breath analysis device combined with a credit card, in accordance with an embodiment of the present invention;

FIG. 4 illustrates a cross-sectional view of the breath analysis device of FIG. 3 with the credit card detached;

FIG. 5 illustrates a detachable credit card and breath analysis device, in accordance with an embodiment of the present invention;

FIG. 6 illustrates a front view of a credit card with a cutout portion, in accordance with an embodiment of the present invention;

FIG. 6A illustrates a back view of the device illustrated in FIG. 6;

FIG. 6B illustrates a cutout portion of a credit card, in accordance with an embodiment of the present invention

FIG. 6C illustrates a cutout portion of a credit card, in accordance with an embodiment of the present invention

FIG. 7 illustrates a combined breath analysis device, credit card, and bottle opener, in accordance with an embodiment of the present invention;

FIG. 7A illustrates a back view of the device illustrated in FIG. 7;

FIG. 8 illustrates a combination breath analysis device and credit card, in accordance with an embodiment of the present invention;

FIG. 8A illustrates the assembly of FIG. 8 with the credit card rotated out of a cavity within the breath analysis device;

FIG. 9 represents a top view of a combination breath analysis device and credit card, in accordance with an embodiment of the present invention;

FIG. 9A is a side view of the device illustrated in FIG. 9; and

FIG. 10 illustrates a credit card having a container coupled thereto, in accordance with an embodiment of the present invention;

### DETAILED DESCRIPTION OF THE DRAWINGS

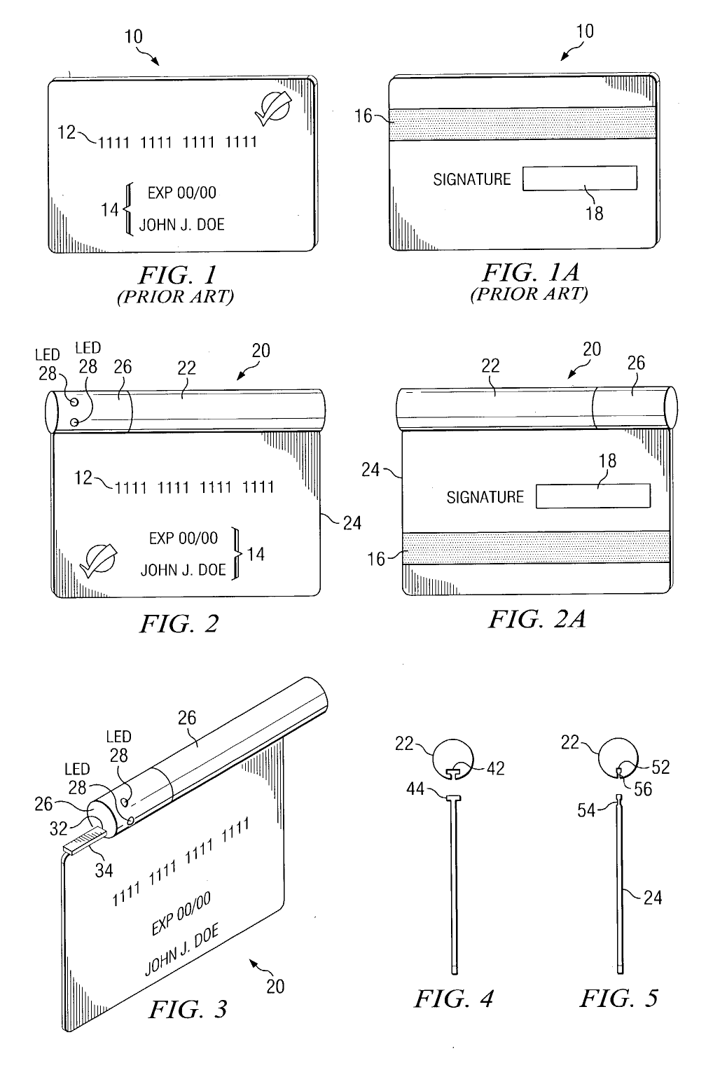

Embodiments of the invention are best understood by referring to FIGS. 1 through 10 of the drawings, like numerals being used with like and corresponding parts of the various drawings.

In general, certain embodiments of the present invention are directed to combining aspects of credit cards and breath analysis devices. While certain personal breath analysis devices are available, consumers do not typically have a breath analysis device (of the type available) present with them when they are using their credit card to purchase alcoholic beverages. As a result, many consumers of alcoholic beverages must travel after consuming the alcohol, and have no idea what their blood alcohol content might be upon leaving an establishment serving alcoholic beverages. Accidents involving the use of alcohol and motor vehicles are well documented and could result in jail time, extensive fines, injury to the intoxicated driver, injury to others, or death.

FIG. 1 illustrates a credit card 10 which may be issued by a credit provider. The term “credit card” as described herein is not limited to cards used to purchase goods and services based on a credit line or loan from a card provider. In the embodiments described below, the term “credit card” is broadly interpreted to encompass traditional cards used to purchase goods and services on credit, as well as debit cards, check cards, prepaid deposit cards, and any other card comprising the basic characteristics of a card illustrated by FIGS. 1 and 1A. Credit card 10 generally comprises credit card body 12, personal data 14, magnetic strip 16, and signature area 18. Other information may be presented on the card such as logos, or holographic designs (not explicitly shown). Additionally, some credit cards have embedded smart chip technology (not explicitly shown), which enables information regarding the cardholder or a particular transaction to be transmitted through the credit processing system to the credit provider.

FIG. 2 illustrates one embodiment of a combined credit card and breath analysis device 20. Combination credit device 20 comprises a breath analysis device 22, a credit card 24 coupled to breath analysis device 22, an input mechanism 26, and a readout 28. Breath analysis devices such as depicted at breath analysis device 22 are commercially available from a wide array of manufacturers and distributors. For example, the ABT-180 manufactured and marketed by Matsutek Enterprises Company, LTD., manufactures a suitable breath analysis device capable of measuring blood alcohol content at levels of 0.05 percent blood alcohol content or above. The operation of the breath analysis device 22 is generally known. Credit card 24 is coupled to breath analysis device 22 so that the credit card and breath analysis device form a single unit. Preferably, magnetic strip 16 is located closer to a bottom edge of the card body of credit card 24 as opposed to being located closer to the upper edge of the conventional credit card of FIG. 1. This facilitates the scanning of card 24 by a user when using a magnetic card reader.

FIG. 3 illustrates a credit card 24 removably coupled to breath analysis device 22. This coupling is accomplished by manufacturing an aperture 32 in device 22, into which the top edge 34 of credit card 24 may be inserted and slid along the length of breath analysis device 22. In one embodiment, aperture 32 and top edge 34 of credit card 24 form a tongue-and-groove connection, thus allowing credit card 24 to be positively connected to breath analysis device 22. Though FIG. 3 illustrates a tongue-and-groove type connection between credit card 24 and breath analysis device 22, any suitable means of connecting credit card 24 and breath analysis device 22 may be used. For example, credit card 24 may be snapped into place in an appropriate aperture formed in breath analysis device 22. Other methods of coupling card 24 to breath analysis device 22 may also be used.

FIG. 4 illustrates a cross-sectional view of breath analysis device 22 and card 24 viewed along a longitudinal axis of breath analysis device 22 and card 24. As illustrated in FIG. 4, aperture 42 is formed along a longitudinal length of, and parallel to the longitudinal axis of, breath analysis device 22. Aperture 42 is operable to receive flange 44 formed on the top edge of credit card 24.

FIG. 5 illustrates an alternative embodiment, and is also viewed as a cross-section taken perpendicular to the longitudinal axes of breath analysis device 22 and credit card 24. In the embodiment illustrated by FIG. 5, aperture 52 is a tongue-and-groove type aperture, operable to accept the top edge of credit card 24. Credit card 24 is secured within breath analysis device 22 by creating indented portion 54 on credit card 24. Indented portion 54 represents a groove that runs along the longitudinal length of the top edge of credit card 24 and is engageable by sides 56 of aperture 52 in breath analysis device 22.

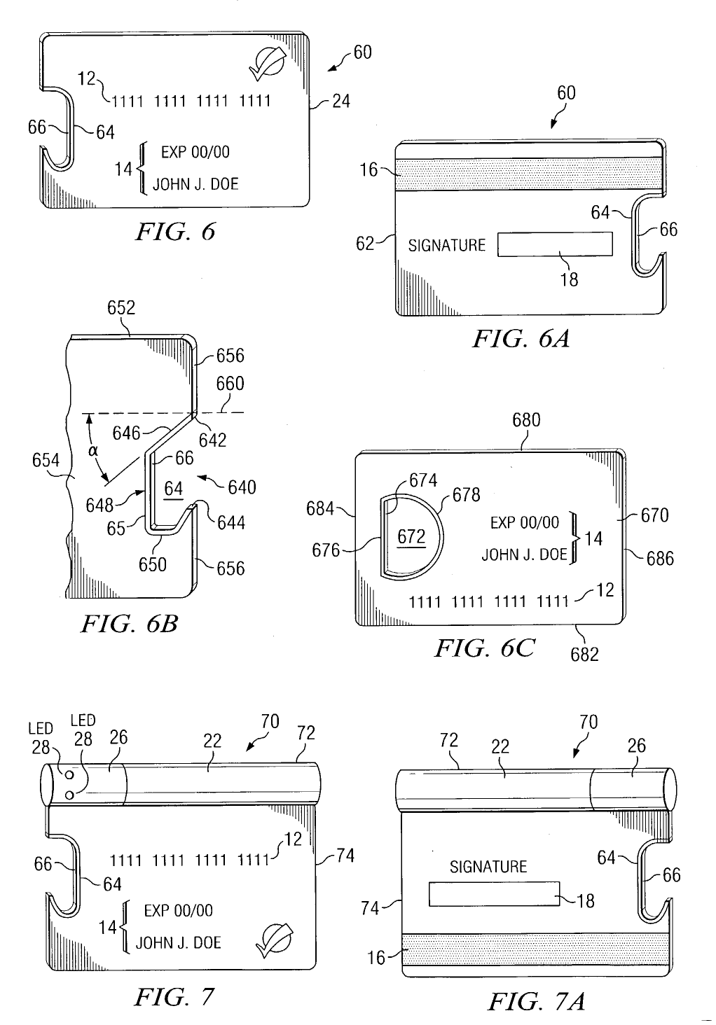

Referring now to FIGS. 6 and 6A, a credit card 62 has a bottle opener 64 formed from cut-out portion 65 which may be operable to open container such as bottles with caps, and the like. Credit card 62 is preferably manufactured from a solid polymer, layered polymers, or a metal alloy suitable for use in credit card manufacture. Additionally, credit card 62 may include reinforcing member 66 disposed along the edge of cutout portion 65. Depending on the material used to create credit card 62, reinforcing member 66 may be necessary to prevent damage to credit card 62. Reinforcing member 66 may be constructed from any suitable polymer, metal, or metal alloy, and may be secured to credit card using adhesive, welding, mechanical coupling, or any other suitable method.

FIG. 6B illustrates bottle opener 64 formed from cutout portion 65 in greater detail. Bottle opener 64 has a recessed area 640, which is preferably formed in the shape generally depicted in FIG. 6B. Beginning at point 642, disposed on an edge 656 of card body 654, recessed portion 640 has a sloped portion 646 having an edge extending inward into card body 654 from edge 656. Sloped portion 646 is not parallel to edge 652. Preferably, the direction of sloped portion 646 is defined by an angle α, wherein the angle α is defined by sloped portion 646 and a line generally parallel to edge 652 and intersecting point 642. Angle α preferably measures between 10 and 50 degrees. Moreover, the edge forming sloped portion 646 does not necessarily have to be linear, but may be a curved portion. Sloped portion 646 terminates into distal portion 648. Distal portion 648 is generally linear and parallel to edge 656 of card body 654. Distal portion 648 is disposed the greatest distance of recessed portion 644 from edge 656. Distal portion 648 terminates into grasping portion 650, which is preferably disposed the greatest distance from line 660 which, as mentioned above, is a line parallel to edge 652. Grasping portion 650 generally forms a concave portion terminating at point 644. Point 644, along with point 642, defines the beginning of recessed portion 640. In addition to the configuration of bottle opener 64 described above, numerous other embodiments will be readily ascertainable by one of ordinary skill in the art.

FIG. 6C illustrates a credit card 670 having a cut-out portion 672 disposed completely within the body of card 670. Cut-out portion 672 is preferably defined by a circular cutout 678, which is operable to open bottles sealed with bottle caps, and the like. Additionally, cut-out portion 672 may have grasping portion 674 which may be generally flat, and is preferably formed to provide a better grasp on the top of a bottle cap. Cut-out portion 672 may be reinforced by reinforcing member 676 to provide added strength for opening bottles without causing damage to credit card 670. In one embodiment, circular portion 678 of cut-out portion 672 is preferably located at approximately an equal distance from top edge 680 and bottom edge 682. Additionally, grasping segment 674 may be formed as a straight line segment approximately parallel to edge 684. Preferably, the length of grasping portion 674 is greater than the radius of the circle defining circular portion 678, but less than the diameter of the circle defining circular portion 678, if the circle was contiguous.

FIGS. 7 and 7A show a front and back view of a combination of credit card 24, breath analysis device 22, and bottle opener 64, respectively. All of the elements of breath analysis device 22 in combination with credit card 24 are the same as described above with respect to FIGS. 2 and 2A. Additionally, the aspects of credit card 24 and bottle opener 64 are present as illustrated in FIGS. 6 and 6A. As illustrated by FIGS. 2, 2A, 6, 6A, 7, and 7A, all of the basic aspects disclosed by FIG. 1 and FIG. 1A, comprising credit card 12, personal information 14, magnetic strip 16 and signature 18 are present in each of the above described embodiments. As long as these aspects are present on a card in such a manner that the card is functional for a user, alterations may be contemplated that would enable the various embodiments described herein.

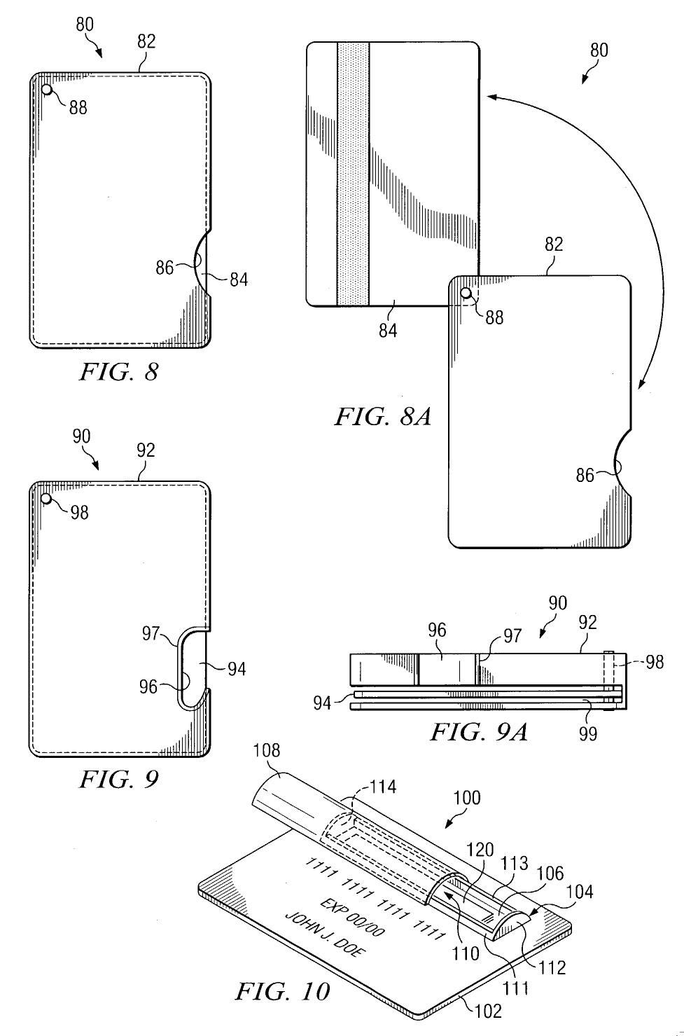

FIGS. 8, 8A, 9 and 9A generally illustrate a combination breath analysis device and credit card 80 wherein a credit card 84 is disposed within a recess (not explicitly shown in FIG. 8) of breath analysis device 82. Credit card 84 is rotatably coupled to breath analysis device 82 by hinge 88. This rotatable coupling allows credit card 84 to be protected within the recess of breath analysis device 82 when not in use. Recess 86 allows a user to grasp credit card 84 to rotate the credit card 84 from within the recess for use. In addition to the rotatable coupling allowing a credit card 84 to be grasped by a user and rotated out of recess 86, various other embodiments may be used. For example, credit card 84 may be automatically rotated from within recess 86. Some examples of embodiments employing an automatic rotatably removable credit card 84 comprise a spring-loaded, user-activated credit card removal system (not explicitly shown) whereby credit card 84 rotates out from recess 86 to an open position. In another embodiment, credit card 84 is fixedly attached to hinge 88, so that a micro-motor, or other suitable device (not explicitly shown), when activated by a user, is operable to rotate credit card 84 out of recess 86 into an extended position. The automatic credit card removal systems as described herein are not exhaustive, and other embodiments may be used to automatically rotate credit card 84 from recess 86 without departing from the spirit and scope of the present invention.

FIGS. 9 and 9A illustrate a top view and a side view, respectively, of a combination breath analysis device and credit card wherein breath analysis device 92 is coupled to credit card 94 in the same manner as illustrated in FIGS. 8 and 8A with respect to credit card 84 and breath analysis device 82. Credit card 94 is coupled to breath analysis device 92 via hinge 98. Additionally, breath analysis device 92 has a concave portion formed therein, which constitutes a bottle opener 96. Similar to the embodiment described in connection with FIGS. 6 and 6A, bottle opener 96 may include reinforcing member 97 depending on the strength of the material used to construct breath analysis device 92. FIG. 9A generally illustrates a side view of the combination breath analysis device and credit card illustrated by FIG. 9. When not in use, credit card 94 may be disposed within recess 99. Preferably, recess 99 is slightly larger in all respects than credit card 94, so that credit card 94 may be fully disposed within recess 94 when not in use.

FIG. 10 illustrates a container 104 coupled to credit card 102. Container 104 comprises a base 106, a lid 108, and a cavity 110. Base 106 further comprises first end 112 and a second end 114 which, when lid 108 is in a closed position, provide a sealed environment within cavity 110. Cavity 110 provides space within container 104, making container 104 operable to store chemical test strips 120. Chemical test strips 120 may be any commercially available test strip to test the blood alcohol content of a user. Examples of chemical test strip 120 are manufactured by Guardian Angel™ and marketed under Personal Alcohol Test™. Test strips 120 may provide a user with an approximation of the user's blood alcohol content when the test strip is exposed to the user's saliva. Similar devices may determine the levels of certain chemicals in a user's breath. Lid 108 may be slideable along guides 111 and 113 to obtain an open or closed configuration. A sealable environment is preferable such that test strips are hermetically sealed until they are put into use. Therefore, test strips 120 may be individually packed and sealed and placed in container 104, or may be removed from the package from which they were originally purchased and placed into cavity 110 of container 104 and then sealed by closing lid 108 over base 106. In one embodiment, container 104 may be removable from credit card 102. In another embodiment, lid 108 may be removable from base 106. In yet another embodiment, lid 108 may be hinged on one side, and opened or closed by rotating lid 108 up or down with respect to card 102, respectively.

Although the present invention has be described in detail, it should be understood that various changes, substitutions, and alterations may be made, without departing from the spirit and scope of the present invention as defined by the claims.

What is claimed is:

1. A combination purchasing device comprising:
a credit card; and
a breath analysis device coupled to the credit card.

2. The combination purchasing device of claim 1, wherein the credit card is removably coupled to the breath analysis device.

3. The combination purchasing device of claim 1, further comprising a bottle opener formed in a body of the credit card.

4. The combination purchasing device of claim 3, wherein the bottle opener is formed as a cutout portion of the credit card.

5. The combination purchasing device of claim 4, wherein the contact portion is formed in an edge of the credit card.

6. The combination purchasing device of claim 5, further comprising a reinforcing member coupled to the bottle opener.

7. The combination purchasing device of claim 1, wherein the credit card is manufactured from a polymer.

8. The combination purchasing device of claim 1, wherein the credit card is manufactured from a metal alloy.

9. The combination purchasing device of claim 4, wherein the credit card is manufactured from a metal alloy.

10. The combination purchasing device of claim 1, further comprising a means for opening containers.

11. The combination purchasing device of claim 9, wherein the means for opening containers is a cutout portion formed in the credit card.

12. The combination purchasing device of claim 2, wherein the credit card is removably coupled to the breath analysis device with a tongue-in-groove connection.

13. The combination purchasing device of claim 12, further comprising a retaining means operable to selectively prevent the credit card from becoming uncoupled to the breath analysis device.

14. A combination purchasing device comprising:
a credit card; and
a bottle opener, wherein the bottle opener is a cutout portion formed in the credit card.

15. The combination purchasing device of claim 14, further comprising a reinforcing member coupled to the bottle opener.

16. The combination purchasing device of claim 14, wherein the credit card is made of a polymer.

17. The combination purchasing device of claim 14, wherein the credit card is made of a metal.

18. The combination purchasing device of claim 14, wherein the credit card is made of an alloy.

19. A credit card holder comprising:
a breath analysis device having a recess formed therein;
a credit card; and
a hinge, wherein the hinge is coupled to the breath analysis device, and wherein the credit card is rotatably coupled to the hinge to selectively move at least a portion of the credit card from a first position within the recess to a second position external to the recess.

20. The credit card holder of claim 19, further comprising an opening mechanism, wherein the opening mechanism is operable to, upon receiving external stimuli, automatically move at least a portion of the credit card from a first position within the recess to a second position external to the recess.

21. The credit card holder of claim 20, wherein the opening mechanism is comprised of a spring.

22. The credit card holder of claim 20, wherein the opening mechanism is comprised of a micro-motor.

23. The credit card holder of claim 19, further comprising a means for opening containers.

24. The credit card holder of claim 23, wherein the means for opening containers comprises a cutout portion formed in the breath analysis device.

25. The credit card holder of claim 19, wherein the breath analysis device is operable to detect chemicals in the breath of a user.

26. A method for manufacturing a combination credit card device comprising the step of coupling a credit card to a breath analysis device.

27. The method of claim 26 further comprising the step of cutting out a portion of the credit card to form a bottle opener.

28. The method of claim 26, wherein the credit card is constructed of a metal alloy.

29. The method of claim 27, further comprising the step of coupling a reinforcing member to at least a part of the cutout portion of the credit card.

30. The method of claim 26, wherein the credit card is non-removably coupled to the breath analysis device.

31. The method of claim 26, wherein the credit card is rotatably coupled to the breath analysis device.

32. The method of claim 31, wherein the breath analysis device is formed with a recess therein, and wherein the recess is operable to store the credit card.

33. The method of claim 26, wherein the breath analysis device is formed with a cutout portion operable to open containers.

34. The method of claim 27, further comprising the step of coupling a reinforcing member to the cutout portion of the breath analysis device.

35. A combination credit card comprising:
a credit card; and
a container disposed on the face of the credit card body, wherein the container is operable to store items.

36. The combination credit card of claim 31, wherein the container is removable from the credit card body.

37. The combination credit card of claim 31, wherein the container, when closed, creates a hermetic seal.

38. The combination credit card of claim 37, wherein the container is operable to store chemical test strips.
